(19) United States
(12) Patent Application Publication
(10) Pub. No.: US 2008/0307165 A1
(43) Pub. Date: Dec. 11, 2008

(54) INFORMATION PROCESSOR, METHOD FOR CONTROLLING CACHE FLASH, AND INFORMATION PROCESSING CONTROLLER

(75) Inventor: Nagano KAZUHIRO, Yokohama (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/121,784

(22) Filed: May 16, 2008

(30) Foreign Application Priority Data
Jun. 8, 2007 (JP) 2007-152896

(51) Int. Cl. G06F 12/00

(52) U.S. Cl. 711/135; 711/E12.001

(57) ABSTRACT

An information processor, a method for controlling cache flush, and an information processing controller that increases the data processing speed by efficiently performing cache flushing on a cache memory. A CPU includes a load/store unit and a flush control unit. The CPU controls data stored in a cache through a cache controller. When detecting an “.f” signal, the flush control unit waits until a single cache line is accessed. When determining that a single cache line has been accessed, the flush control unit issues a cache flush instruction to a cache controller.

### BACKGROUND OF THE INVENTION

The present invention relates to an information processor for controlling a cache memory, a method for controlling cache flush, and an information processing controller.

Frequently used data may be stored in a high-speed storage device to read data at high speeds. For example, a memory enables data to be read and written at higher speeds than a hard disk. Therefore, frequently used data may be stored in a memory to enable processing at higher speeds than when storing data entirely in a hard disk. In this case, the memory serves as a cache for the hard disk. Such a cache memory is normally formed by a high-speed static RAM that has a small capacity. In such a case, the memory, which has a fixed capacity, stores part of a data body and corresponding addresses in addition to attribute information, such as a flag.

Referring to FIG. 6, a CPU 10 includes a load/store unit 12. The load/store unit 12 designates an address and issues an R/W instruction for a cache controller 31. Here, the term “address” refers to an accessed address, and the term “R/W instruction” refers to a read or write identification signal. In this case, the cache controller 31 controls the data stored in a cache 32. The CPU 10 includes a flush function unit 1 which designates an address and issues a cache flush instruction for the cache controller 31. The cache flush instruction is a signal for determining whether or not to perform flushing. In this case, the cache controller 31 flushes each line in the cache 32.

Japanese Laid-Open Patent Publication No. 2005-149290 discusses a scheme for increasing processing speeds in a cache memory. In this information processor, at least some of the data stored in a memory device, which is subject to data reading, is cached. The information processor includes a cache memory that is accessible through a plurality of accessing modes, which include at least a write-back mode or a write-through mode. During the execution of a program, the plurality of access modes are switched to access the cache memory.

In such hardware, the capacity of a cache is limited. Thus, processing speeds may be increased by keeping data having high priority in the cache. Accordingly, data that is no longer referred to in an application program should immediately be flushed from the cache to keep other high priority data in the cache and increase the processing speed. If such processing can easily be realized, this would be convenient for a person writing a program.

Many processors support instructions for flushing a cache. When using this feature to flush data, which is not longer referred to, from an application program, the application program would have to be changed to execute cache control. More specifically, a normal cache flush instruction is effective entirely for a single cache line. Thus, loop unwinding must be performed to make changes such as adjusting the unit in which data processing is performed to a single cache line. For example, in a PowerPC (registered trademark), processing in 32-byte units must be performed in the interior of a loop to avoid overlapped flushing for the same address. Therefore, when performing accessing in 4-byte units, as shown by code P10 in FIG. 7, a cache flush instruction must be issued for 32-byte accesses in accordance with the size of a cache line, as shown by code P11. This would increase the code size and lower the readability.

Further, a cache flush instruction may be added by using an inline assembler that embeds an assembler code in part of a program written in C language. However, in such a case, a machine-biased code may mix and lower the predictability of the program, increase the machine type dependency, and lower the interchangeability.

### SUMMARY OF THE INVENTION

It is an object of the present invention to provide an information processor, a method for controlling cache flush, and an information processing controller that increases the data processing speed by efficiently performing cache flushing on a cache memory.

One aspect of the present invention is an information processor including a data cache for storing data, a load/store unit for controlling the data cache, and a flush control unit for issuing a cache flush instruction to the data cache. The flush control unit includes a transfer width information acquisition means for acquiring transfer width information of data from the load/store unit. An address information acquisition means acquires transfer destination address information that controls the data cache from the load/store unit. A flush instruction output means detects accessing of a single cache line based on the transfer destination address information acquired by the address information acquisition means and the transfer width information acquired by the transfer width acquisition means when the load/store unit is executing a program. The flush instruction output means issues a cache flush instruction in accordance with the detection.

Another aspect of the present invention is a method for controlling cache flush with an information processor including a data cache for storing data, a load/store unit for controlling the data cache, and a flush control unit for issuing a cache flush instruction to a data cache. The method includes acquiring transfer width information of data from the load/store unit with the flush control unit, acquiring transfer destination address information that controls the data cache from the load/store unit with the flush control unit, and detecting accessing of a single cache line based on the acquired transfer destination address information and transfer width information when the load/store unit is executing a program and, in accordance with the detection, issuing a cache flush instruction with the flush control unit.

A further aspect of the present invention is an information processing controller including a load/store unit, connected to a data cache for storing data, for controlling the data cache, and a flush control unit for issuing a cache flush instruction to a data cache. The flush control unit includes a transfer width information acquisition means for acquiring transfer width information of data from the load/store unit, an address information acquisition means for acquiring transfer destination address information that controls the data cache from the load/store unit, and a flush instruction issuance means for detecting accessing of a single cache line based on the transfer destination address information acquired by the address information acquisition means and the transfer width information acquired by the transfer width acquisition means when the load/store unit is executing a program. The flush instruction issuance means issues a cache flush instruction in accordance with the detection.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing an information processor according to a preferred embodiment of the present invention;

FIG. 2 is a block diagram showing a function block of a flush control unit in the preferred embodiment:

FIG. 3 is a flowchart of a processing performed in the preferred embodiment;

FIG. 4 is a diagram showing a program used in the preferred embodiment;

FIG. 5 is a diagram showing data transfer in the preferred embodiment;

FIG. 6 is a block diagram showing an information processor in the prior art; and

FIG. 7 is a diagram showing a coding in the prior art.

### DETAILED DESCRIPTION OF THE PREFERRED EMBODIMENTS

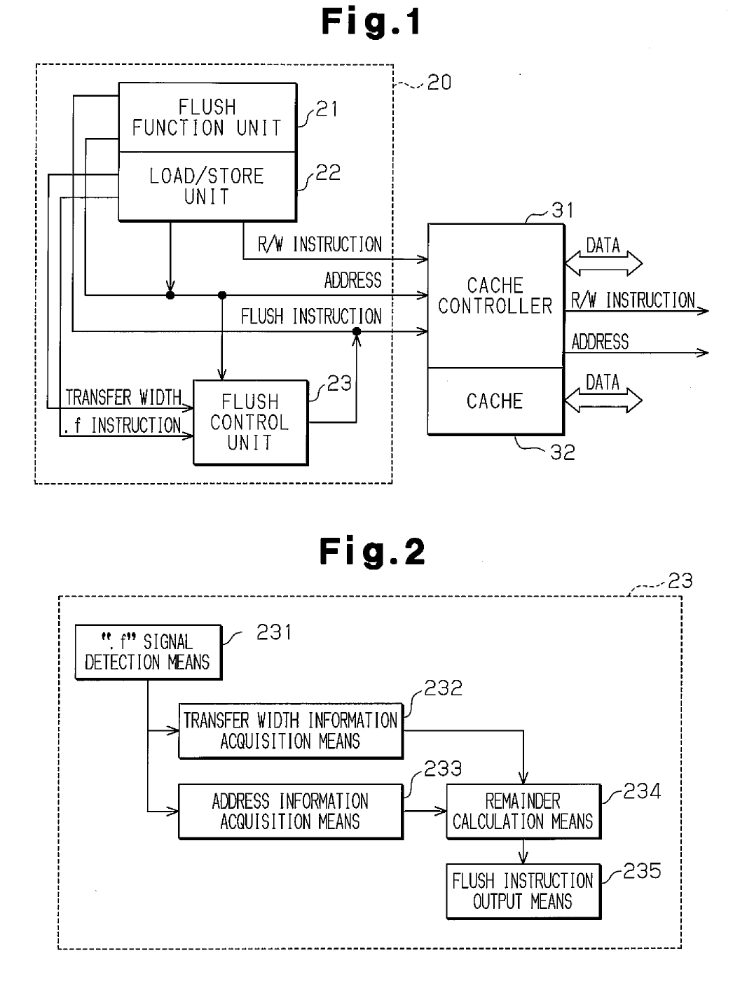

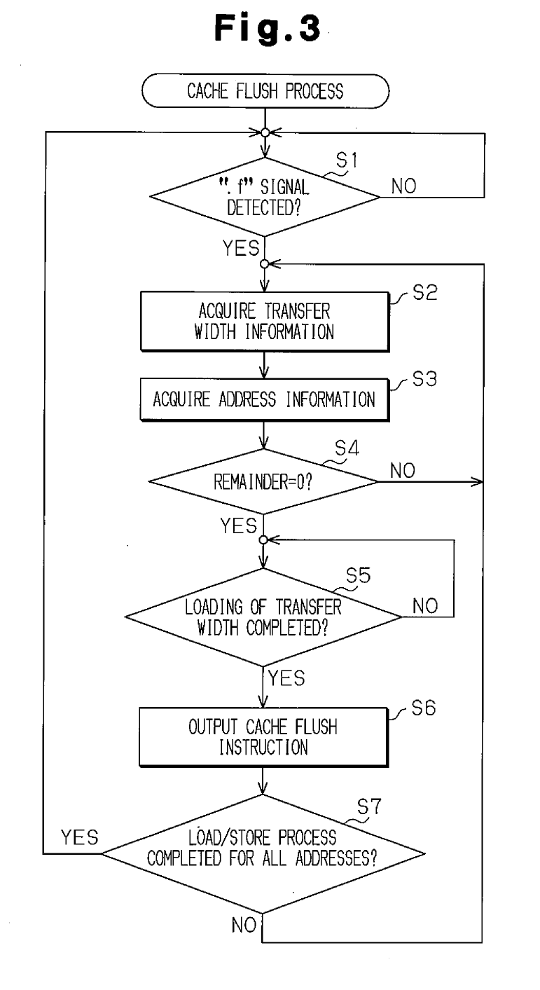

A preferred embodiment of an information processor according to the present invention will now be discussed with reference to FIGS. 1 to 5. In the preferred embodiment, after transferring data from a predetermined address, the transferred data is not reused. For example, as shown in FIG. 5, data stored in memory region M1, which includes addresses 0 to 100, is transferred to memory region M2, which includes addresses 8000 to 8100.

In the information processor of the preferred embodiment, referring to FIG. 1, a CPU 20 functions as an information processing controller. The CPU 20 includes a load/store unit 22. The load/store unit 22 designates the address of a transfer destination and issues an R/W instruction to a cache controller 31.

The cache controller 31 and a cache 32 form a data cache. The cache controller 31 controls data stored in a cache 32.

The CPU 20 includes a flush function unit 21. The flush function unit 21 designates an address and issues a cache flush instruction to the cache controller 31. In such a case, the cache controller 31 flushes each line in the cache 32.

Further, the CPU 20 includes a flush control unit 23, which supports the execution of cache control. The load/store unit 22 provides the flush control unit 23 with address information of the transfer destination, transfer width information, and a load/store with flush control instruction (“.f” instruction). Referring to FIG. 2, the flush control unit 23 includes a “.f” signal detection means 231, a transfer width information acquisition means 232, an address information acquisition means 233, a remainder calculation means 234, and a flush instruction output means 235. The flush instruction output means 235 functions as a flush instruction issuance means.

The operation of the information processor will now be discussed. The information processor sequentially accesses successive addresses. Further, the information processor is not applied when decrementing addresses. The information processor flushes data from a cache subsequent to accessing. In addition, a single cache line is formed by 32 bytes.

When the data stored in the cache is accessed four bytes at a time, the accessing of a single cache line would be completed when the lower rank five bits of an address is “28”. When “address+transfer width” is an aliquot part of “32” (cache size), cache flushing is performed upon detection transfer completion of a single cache line.

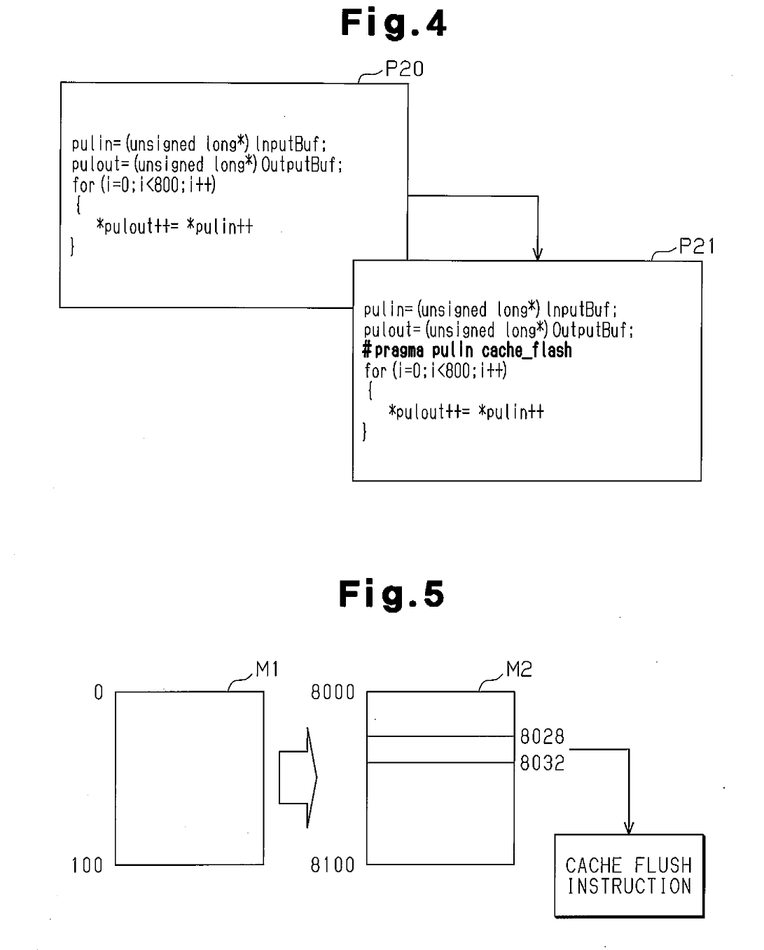

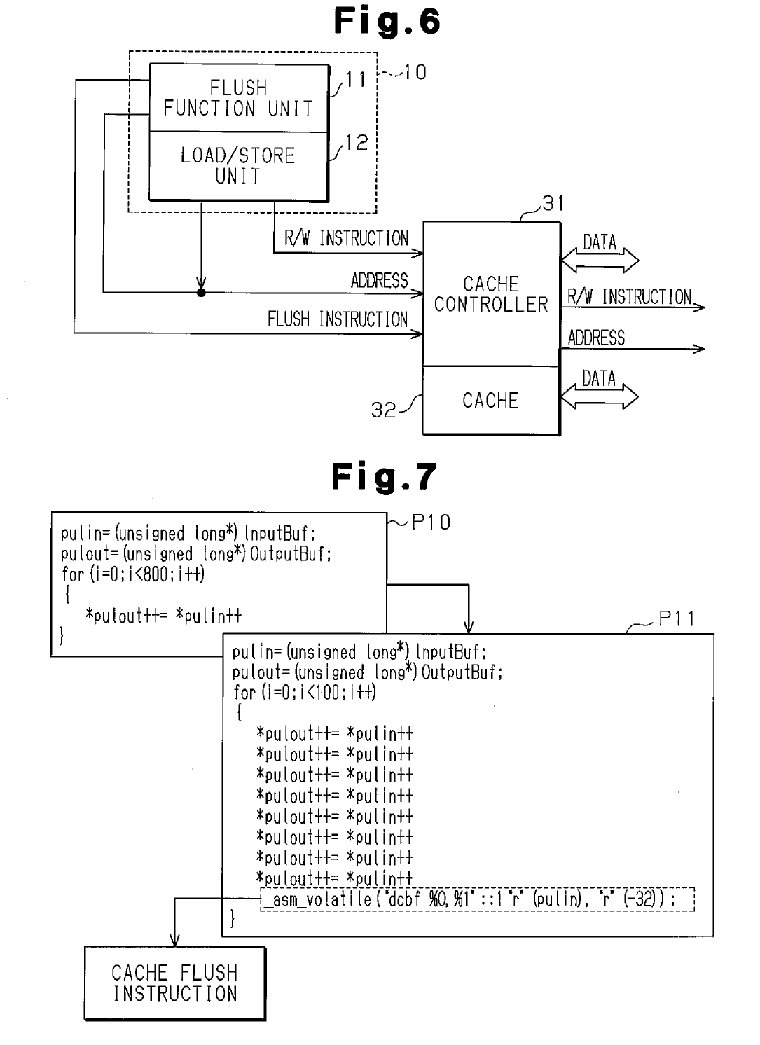

The preferred embodiment uses a pragma, which is a compiler control sentence for transferring specific information to a compiler. A load process that is related with a pointer designated by the pragma is compiled in an assembly instruction (*.f instruction) of a “load with cache flush” instruction. For example, for a code P20 shown in FIG. 4, “#pragma pulin cache_flash” is inserted as shown by code P21.

The flush control unit 23 performs an “.f”, signal detection process. In the preferred embodiment, “lbz” represents a one-byte load instruction, “lhz” represents a two-byte load instruction, and “lwz” represents a four-byte load instruction. Further, “ldz.f” represents a one-byte load with cache flush instruction, “lhz.f” represents a two-byte load with cache flush instruction, and “lwz.f” represents a four-byte load with cache flush instruction. When an “.f” instruction is executed, an “.f” signal is provided to the flush control unit 23. Further, the “.f” signal detection means 231 of the flush control unit 23 acquires the “.f” signal. In this case, the “.f” signal detection means 231 validates the transfer width information acquisition means 232 and the address information acquisition means 233.

The flush control unit 23 performs a transfer width information acquisition process (step S2). More specifically, the transfer width information acquisition means 232 of the flush control unit 23 acquires transfer width information from the load/store unit 22. The transfer width corresponding to a load instruction is represented by “N”.

Furthermore, the flush control unit 23 performs an address information acquisition process step S3). More specifically, the address information acquisition means 233 of the flush control unit 23 acquires address information from the load/store unit 22. The lower rank five bits of an address is represented by “X”.

Next, the flush control unit 23 performs a remainder check process (step S4). More specifically, the remainder calculation means 234 uses the transfer width (N) acquired by the transfer width information acquisition means 232 and the address (X) acquired by the address information acquisition means 233 to determine whether or not to perform cache flushing after a load/store process. The remainder calculation means 234 determines whether the remainder is “0” when dividing “X+N” by the “byte size of a single cache line (“32” in the preferred embodiment). The flush control unit 23 waits (“NO” in step S4) until the remainder becomes “0”. As shown in FIG. 5, the remainder becomes “0” when address 8028 is acquired as the transfer destination address and a transfer width (N) of four bytes is recorded from address 8028.

When the remainder becomes “0” (“YES” in step S4), this would indicate that the load/store instruction has accessed every one of the addresses in a single cache line. Thus, the flush control unit 23 waits (“No” in step S5) until the loading of data corresponding to the present transfer width is completed.

The loading of data corresponding to the present transfer width is determined when acquiring the next address (“YES” in step S5). In this case, the flush control unit 23 performs a process for outputting a cache flush instruction (step S6). The flush instruction output means 235 of the flush control unit 23 provides the cache controller 31 with a cache flush instruction to flush the cache line.

The flush control unit 23 repeats steps S2 to S7 until completing the load/store process for every address when a “load with cache flush” instruction is issued.

The information processor of the preferred embodiment has the advantages described below.

In the preferred embodiment, a load process that is related with a pointer designated by a pragma, which is a compiler control sentence for transferring specific information to a compiler, is compiled in an assembly instruction (*.f instruction) of a “load with cache flush” instruction. By just adding a compiler control sentence to a source code, functions that are the same or more sophisticated than when using a cache flush instruction are implemented. Particularly, when developing an application program with C language, speed increases resulting from cache control can be expected just by adding a compiler control sentence or the like. This eliminates the need to perform loop unwinding or use an inline assembler instruction.

In the preferred embodiment, the flush control unit 23 issues a cache flush instruction when the transfer of a single cache line of data is completed. This efficiently performs cache flushing for each cache line.

It should be apparent to those skilled in the art that the present invention may be embodied in many other specific forms without departing from the spirit or scope of the invention. Particularly, it should be understood that the present invention may be embodied in the following forms.

A cache does not have to be formed for 32 bytes as in the preferred embodiment and may be determined in accordance with the size of the cache line.

In the preferred embodiment, when acquiring the next address and determining that the loading of data corresponding to the present transfer width has been completed (“YES” in step S5), the flush control unit 23 performs the process for outputting a cache flush instruction (step S6). However, the storing of data in a single cache line is not limited to such a manner.

The present examples and embodiments are to be considered as illustrative and not restrictive, and the invention is not to be limited to the details given herein, but may be modified within the scope and equivalence of the appended claims.

What is claimed is:

1. An information processor comprising:
a data cache for storing data;
a load/store unit for controlling the data cache; and
a flush control unit for issuing a cache flush instruction to the data cache, wherein the flush control unit includes:
a transfer width information acquisition means for acquiring transfer width information of data from the load/store unit;
an address information acquisition means for acquiring transfer destination address information that controls the data cache from the load/store unit; and
a flush instruction output means for detecting accessing of a single cache line based on the transfer destination address information acquired by the address information acquisition means and the transfer width information acquired by the transfer width acquisition means when the load/store unit is executing a program, wherein the flush instruction output means issues a cache flush instruction in accordance with the detection.

2. The information processor according to claim 1, wherein the flush control unit allows the flush instruction output means to issue the cache flush instruction when acquiring a signal corresponding to a condition-added load instruction from the load/store unit.

3. The information processor according to claim 1, wherein the flush instruction output means adds a transfer width to a transfer destination address acquired from the load/store unit, calculates a remainder when dividing data amount for a single cache line, and issues the cache flush instruction based on the remainder.

4. A method for controlling cache flush with an information processor including a data cache for storing data, a load/store unit for controlling the data cache, and a flush control unit for issuing a cache flush instruction to a data cache, the method comprising:
acquiring transfer width information of data from the load/store unit with the flush control unit;
acquiring transfer destination address information that controls the data cache from the load/store unit with the flush control unit; and
detecting accessing of a single cache line based on the acquired transfer destination address information and transfer width information when the load/store unit is executing a program and, in accordance with the detection, issuing a cache flush instruction with the flush control unit.

5. An information processing controller comprising:
a load/store unit, connected to a data cache for storing data, for controlling the data cache; and
a flush control unit for issuing a cache flush instruction to a data cache, wherein the flush control unit includes:
a transfer width information acquisition means for acquiring transfer width information of data from the load/store unit;
an address information acquisition means for acquiring transfer destination address information that controls the data cache from the load/store unit; and
a flush instruction issuance means for detecting accessing of a single cache line based on the transfer destination address information acquired by the address information acquisition means and the transfer width information acquired by the transfer width acquisition means when the load/store unit is executing a program, wherein the flush instruction issuance means issues a cache flush instruction in accordance with the detection.
